(19) United States
(12) Patent Application Publication
(10) Pub. No.: US 2015/0302976 A1
(43) Pub. Date: Oct. 22, 2015

(54) EFFECTIVE MAGNETIC SHIELD FOR ON-CHIP INDUCTIVE STRUCTURES

(71) Applicant: QUALCOMM Incorporated, San Diego, CA (US)

(72) Inventors: Richard Tzewei Chang, Sunnyvale, CA (US); Amirpouya Kavousian, San Jose, CA (US)

(21) Appl. No.: 14/255,587

(22) Filed: Apr. 17, 2014

(51) Int. Cl. H01F 27/28; H01F 41/00

(52) U.S. Cl. CPC H01F 27/2885; H01F 41/00

(57) ABSTRACT

A magnetic shield for an inductor is disclosed that may substantially reduce unwanted magnetic coupling from other inductive circuitry. An inductive apparatus includes an inductor and a magnetic shield to shield the inductor from magnetic coupling effects. The magnetic shield includes an inductive ring formed from a plurality of turns surrounding the inductor. The magnetic shield may be used to reduce a magnetic coupling between the inductor and an inductive circuit element. Thus, the number of turns of the inductive ring may be based on the magnetic coupling between the inductor and the inductive circuit element. Further, a distance between the magnetic shield and the inductor may be based on the number of turns of the inductive ring. The distance between the magnetic shield and the inductor is to offset a magnetic coupling between the inductor and the magnetic shield.

### TECHNICAL FIELD

The present embodiments relate generally to inductive circuits, and specifically to magnetic shields for reducing magnetic coupling between on-chip inductors.

### BACKGROUND OF RELATED ART

Inductors and transformers are used in a wide variety of integrated circuit applications including radio frequency (RF) integrated circuit applications. An on-chip inductor is a passive electrical component that can store energy in a magnetic field created by the current passing through it. An inductor can be a conductor shaped as a coil which includes one or more “turns.” The turns concentrate the magnetic field flux induced by current flowing through each turn of the conductor in an “inductive” area within the inductor turns. The number of turns and the size of the turns affect the inductance.

On-chip inductors are typically formed as helical or spiral traces in conductive layers (e.g., to form inductor turns). However, due to limitations in chip size, the performance of such on-chip inductors may be affected by magnetic coupling with other on-chip inductive circuitry. For example, magnetic coupling from on-chip inductors may cause unwanted spurs that can affect receive sensitivity, coexistence performance, and transmit mask or regulatory compliance. Conventional methods of reducing magnetic coupling typically involve placing a single-turn “shielding” ring around an on-chip inductor.

It is desirable to further reduce unwanted magnetic coupling between an on-chip inductor and another inductive element without reducing the inductance and/or quality factor of the on-chip inductor.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A magnetic shield for an inductor is disclosed that may substantially reduce unwanted magnetic coupling, compared to conventional shielding techniques, without further sacrificing the performance of the inductor. In accordance with the present embodiments, an inductive apparatus is disclosed that includes an inductor and a magnetic shield to shield the inductor from magnetic coupling effects (e.g., resulting from circuits or components external to the magnetic shield). The magnetic shield includes an inductive ring formed from a plurality of (e.g., at least two) turns surrounding the inductor. Specifically, the effectiveness of the shielding may be directly proportional to the number of turns of the inductive ring, wherein a greater number of turns correlates with a greater reduction in magnetic coupling.

The magnetic shield may be used to reduce a magnetic coupling between the inductor and an external inductive circuit element. The number of turns of the inductive ring may be based on the magnetic coupling between the inductor and the inductive circuit element. Further, a distance between the magnetic shield and the inductor may be based on the number of turns of the inductive ring. The distance between the magnetic shield and the inductor may correspond with a circumference of the inductive ring. For example, the distance between the magnetic shield and the inductor is to offset a magnetic coupling between the inductor and the magnetic shield. Thus, a greater number of turns may correlate with a greater distance between the magnetic shield and the inductor.

For some embodiments, the magnetic shield may include a plurality of (e.g., at least two) inductive rings. For example, the number of inductive rings may be based on the magnetic coupling between the inductor and the inductive circuit element. The distance between the magnetic shield and the inductor may thus be based on the number of inductive rings, wherein a greater number of inductive rings correlates with a greater distance between the magnetic shield and the inductor. Specifically, the distance between the magnetic shield and the inductor may correspond with an average circumference of the plurality of inductive rings.

As described in greater detail below, a magnetic shield that employs a multi-turn inductive ring may significantly reduce unwanted magnetic coupling compared to conventional shielding techniques. Furthermore, by increasing the separation distance between the magnetic shield and the inner inductor, the reductions in magnetic coupling may be achieved without further sacrificing the performance and/or quality of the inductor.

### BRIEF DESCRIPTION OF THE DRAWINGS

The present embodiments are illustrated by way of example and are not intended to be limited by the figures of the accompanying drawings, where:

FIG. 1 shows an inductor with magnetic shielding.

FIG. 2 depicts an inductive apparatus with a magnetic shield comprising a multi-turn inductive ring in accordance with some embodiments.

FIG. 3 is a lumped circuit model of an inductive system with magnetic shielding in accordance with some embodiments.

FIG. 4 depicts an inductive apparatus with a magnetic shield comprising multiple inductive rings in accordance with some embodiments.

FIG. 5 is an illustrative flow chart depicting an exemplary operation for constructing an inductive apparatus in accordance with some embodiments.

FIG. 6 is an illustrative flow chart depicting a more detailed operation for constructing an inductive apparatus in accordance with some embodiments.

FIG. 7 is an illustrative flow chart depicting a more detailed operation for construction an inductive apparatus in accordance with other embodiments.

Like reference numerals refer to corresponding parts throughout the drawing figures.

### DETAILED DESCRIPTION

The present embodiments are described below in the context of on-chip inductors for simplicity only. It is to be understood that the present embodiments are equally applicable to magnetically shielding inductors made from discrete, integrated, and/or printed circuit components. In addition, the present shielding embodiments are not limited to inductors, but can be applied to any type of circuitry having inductive properties (e.g., transformers). As used herein, the term “inductor” may refer to inductive elements formed by a wire, a coil, a winding, and/or conductive traces formed on a silicon chip. Thus, the terms “inductor,” “coil,” and “winding” may be used interchangeably herein. Further, as used herein, the term “magnetic coupling” refers to the relationship between two circuit elements (e.g., inductors) wherein current changes in one element induces (e.g., through mutual inductance) a voltage and/or current in the other element.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices may be shown in block diagram form to avoid obscuring the present disclosure. The interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

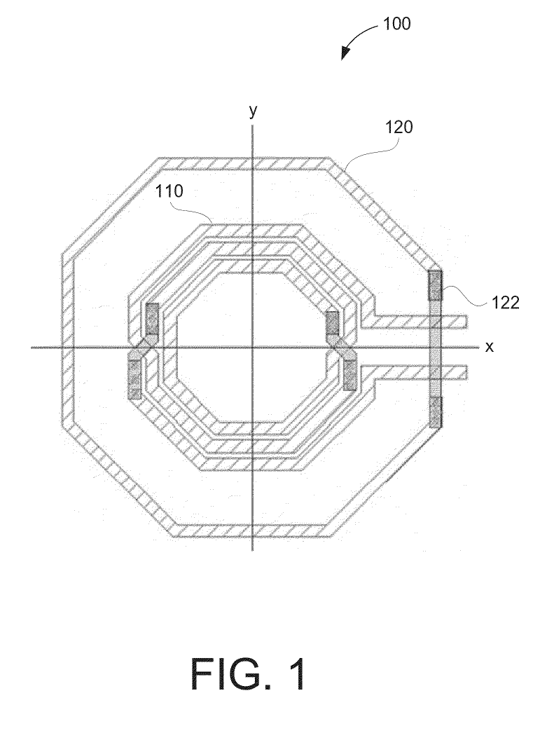

FIG. 1 shows an inductor with magnetic shielding. An inductive apparatus 100 includes an inductor 110 and a magnetic shield 120. The ends of the magnetic shield 120 are shorted via a connecting element 122, thus forming a closed loop around the inductor 110. When magnetic fields (e.g., from other on-chip circuitry) pass through the magnetic shield 120, a current is induced in the closed loop which creates a magnetic field in the opposite direction. The opposing magnetic field generated by the magnetic shield 120 counters the effects of external magnetic fields, and thereby reduces magnetic coupling between the inner inductor 110 and other on-chip circuitry. As a result of the induced currents, there may also be magnetic coupling between the magnetic shield 120 and the inner inductor 110. Thus, the single-ring magnetic shield 120 of FIG. 1 may reduce the effective inductance and quality factor (Q) of the inner inductor 110, while providing only limited reduction in magnetic coupling with other on-chip circuitry.

As mentioned above, it is desirable to shield on-chip inductors from unwanted magnetic coupling with other inductive circuitry. At least one of the problems associated with conventional magnetic shielding techniques is that they provide only a limited reduction in magnetic coupling, which may not be optimized for a particular application or circuit configuration. For example, the amount of magnetic coupling (e.g., mutual inductance) between two inductors depends on the number of turns in each coil, as well as the distance or separation between the inductors. The present embodiments recognize that the optimal amount of magnetic shielding that may be desirable for a particular application varies depending on the design and/or layout of on-chip circuitry. Accordingly, magnetic shields disclosed herein may provide a degree of magnetic shielding (for an inductor) that is optimized for any particular application.

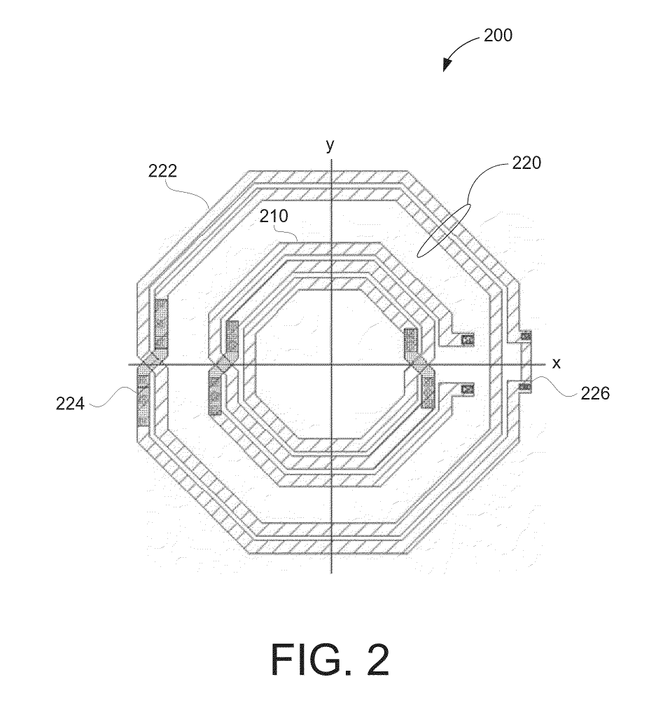

FIG. 2 depicts an inductive apparatus 200 with a magnetic shield comprising a multi-turn inductive ring in accordance with some embodiments. The inductive apparatus 200 includes an inductor 210 and a magnetic shield 220. The inductor 210 and/or magnetic shield 220 may correspond to conductive traces formed on a substrate (e.g., on an IC chip). The magnetic shield 220 surrounds the inductor 210 and shields it from unwanted magnetic coupling effects. For some embodiments, the magnetic shield 220 includes an inductive ring 222 with multiple turns. For example, each turn of the inductive ring 222 may be disposed on the same layer (e.g., silicon) of an IC chip or device. A connecting element 224 may be disposed on a different layer of the IC chip to connect the turns (e.g., through vias in the silicon) while at the same time preventing them from crossing and/or intersecting one another. Alternatively, each turn of the inductive ring 222 may be disposed on a different layer of the IC chip and connected using vias.

The ends of the inductive ring 222 are shorted via a connecting element 226, thus forming a closed loop around the inductor 210. For some embodiments, the connecting element 226 may be disposed on the same layer of the IC chip as the turns of the inductive ring 222. For other embodiments, the connecting element 226 may be disposed on a different layer of the IC chip, for example, so as not to interfere with connections leading into and/or out from the inner inductor 210. It should be noted that the magnetic shield 220 is illustrated in FIG. 2 as a two-turn inductive ring for simplicity only, and may have any number (N) of turns in other embodiments. Further, it is to be noted that embodiments of the magnetic shield 220 are not limited to a circular (or octagonal) shape. For example, in other embodiments, the magnetic shield 220 may be in the shape of a square, triangle, and/or any other shape that forms a closed loop around the inductor 210.

When magnetic fields (e.g., from other on-chip circuitry) pass through the magnetic shield 220, a current is induced in the closed loop which creates a magnetic field in the opposite direction. The opposing magnetic field generated by the magnetic shield 220 counters the effects of external magnetic fields passing through the inner inductor 210, thereby reducing a magnetic coupling between the inner inductor 210 and other nearby inductive circuitry. As described in greater detail below, the magnitude of the opposing magnetic field is proportional to the number of turns of the inductive ring 222. Thus, even greater reductions in magnetic coupling may be achieved by increasing the number of turns of the inductive ring 222.

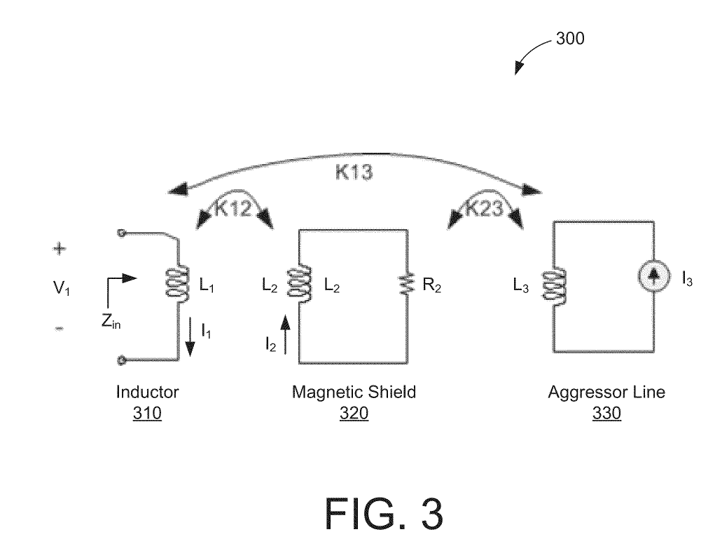

FIG. 3 is a lumped circuit model of an inductive system 300 with magnetic shielding in accordance with some embodiments. The system 300 includes an inductor 310, a magnetic shield 320, and an aggressor line 330. For simplicity, the subscripts 1, 2, and 3 are used to denote physical or electrical properties of the inductor 310, the magnetic shield 320, and the aggressor line 330, respectively. For example, the inductor 310 has an inductance L₁, the magnetic shield 320 has an inductance L₂, and the aggressor line has an inductance L₃. Further, K₁₃ is the “original” coupling factor between the inductor 310 and the aggressor line 330 (e.g., in absence of the magnetic shield 320 present); K₁₂ is the coupling factor between the inductor 310 and the magnetic shield 320, and K₂₃ is the coupling factor between the magnetic shield 320 and the aggressor line 330.

As described above, the magnetic shield 320 is to shield the inductor 310 from unwanted magnetic coupling effects. More specifically, the magnetic shield 320 is to reduce a magnetic coupling (e.g., mutual inductance) between the inductor 310 and the aggressor line 330. For purposes of discussion, the aggressor line 330 may be any arbitrary circuit component that produces an induced magnetic field. For example, the aggressor line 330 may correspond to an inductor, a transformer, and/or a conductive trace (e.g., single or differential signal line) having a characteristic inductance. For some embodiments, the aggressor line 330 may be provided on the same IC chip and/or substrate as the inductor 310. For other embodiments, the aggressor line 330 may be on a separate chip or substrate that is close enough in proximity to the inductor 310 to exhibit mutual inductance.

To calculate the effect of the magnetic shield 320 in reducing spurs in the inductor 310, we start with the equations:

V₁=(M₁₂S)I₂+(M₁₃S)I₃

V₂=(L₂S)I₂+(M₂₃S)I₃

Further, V₂ can also be expressed as:

V₂=−R₂I₂

Substituting V₂ and solving for I₂ yields:

$${I}_{2} = - ( \frac{{M}_{23} S}{{R}_{2} + {L}_{2} S} ) {I}_{3}$$

Substituting I₂ and solving for V₁ yields:

$${V}_{1} = - ( {M}_{12} S ) ( \frac{{M}_{23} S}{{R}_{2} + {L}_{2} S} ) {I}_{3} + ( {M}_{13} S ) {I}_{3}$$

Assuming the quality factor (Q) of the magnetic shield 320 is high (e.g., |L₂S|>>R), the above equation may be reduced to:

$${V}_{1} = [ - ( \frac{{M}_{12} {M}_{23} S}{{L}_{2}} ) + {M}_{13} S ] {I}_{3}$$

Substituting Mᵢⱼ=Kᵢⱼ*sqrt(Lᵢ*Lⱼ) yields:

V₁=\sqrt{L₁L₃}(K₁₃−K₁₂K₂₃)SI₃

The spur ratio (with versus without the magnetic shield 320) can therefore be expressed as:

$$SR = \frac{{K}_{13} - {K}_{12} {K}_{23}}{{K}_{13}}$$

Accordingly, the magnetic shield 320 may reduce the magnetic coupling between the inductor 310 and the aggressor line 330 by a factor of SR. As shown above, SR is inversely proportional to K₂₃ (e.g., the coupling factor between the magnetic shield 320 and the aggressor line 330). Thus, a higher K₂₃ may result in a lower SR. In other words, the magnetic coupling between the inductor 310 and the aggressor line 330 may be reduced by increasing the coupling factor (K₂₃) between the magnetic shield 320 and the aggressor line 330. For example, K₂₃ may be expressed in terms of the mutual inductance M₂₃ between the magnetic shield 320 and the aggressor line 330:

$${K}_{23} = \frac{{M}_{23}}{\sqrt{{L}_{2} {L}_{3}}}$$

Since the mutual inductance for an N-turn ring is N times the mutual inductance of a single-turn ring, it follows that M₂₃ is directly proportional to N:

M₂₃(N)=N*M₂₃(1).

Since K₂₃ is proportional to M₂₃, it follows that K₂₃ may also be increased by increasing N.

As demonstrated above, the coupling factor (K₂₃) between the magnetic shield 320 and the aggressor line 330 may be increased by increasing the number of turns (N) of the magnetic shield 320. Further, since SR is inversely proportional to K₂₃, increasing the number of turns of the magnetic shield 320 further reduces the magnetic coupling between the inductor 310 and the aggressor line 330.

It should be noted that the presence of the magnetic shield 320 also affects the inductance (L1) of the inductor 310. This may be demonstrated by first isolating the inductor 310 and the magnetic shield 320 (e.g., assuming the aggressor line 330 is not present in the inductive system 300). For example, we then have the equations:

V₁=R₁I₁+jωL₁I₁+jωM₁₂I₂

V₂=jωL₂I₂+jωM₁₂I₁

V₂=−R₂I₂

From the above equations, the input impedance seen at the inductor 310 can be expressed as (Zᵢₙ=V₁/I₁):

$${Z}_{in} = jω [ \frac{{L}_{1} - {M}_{12}^{2} {L}_{2} {ω}^{2}}{{R}_{2}^{2} + {( {L}_{2} ω )}^{2}} ] + {R}_{1} + \frac{{R}_{2} {M}_{12}^{2} {ω}^{2}}{{R}_{2}^{2} + {( {L}_{2} ω )}^{2}}$$

Assuming a high Q for the magnetic shield 320 yields:

$${Z}_{in} = jω ( 1 - {K}_{12}^{2} ) {L}_{1} + {K}_{12}^{2} \frac{{L}_{1} ω}{{Q}_{2}} + {R}_{1}$$

Accordingly, the magnetic shield 320 reduces the inductance of the inductor 310 by a factor of (1−K₁₂²). Moreover, increasing the number of turns (N) of the magnetic shield 320 may also have the effect of increasing M₁₂, and thus K₁₂. However, this problem may be mitigated by increasing the distance or amount of separation between the inductor 310 and the magnetic shield 320 (e.g., by increasing the circumference and/or diameter of the magnetic shield 320). For example, a magnetic shield 320 that is further from the inductor 310 induces a lower current (and corresponding magnetic field) than a magnetic shield 320 placed closer to the inductor 310. With reference to FIG. 2, because the magnetic shield 220 surrounds or circumscribes the inductor 210, the separation distance between the magnetic shield 220 and the inductor 210 may be increased by increasing the circumference and/or diameter of the inductive ring 222.

Table 1 illustrates a set of test results comparing the effects of single- and multi-turn inductive rings on magnetic coupling.

TABLE 1

| # | | | | | Simulated | |
|---|---|---|---|---|---|---|
| Turns | Distance | | | | Effective | SR |
| (N) | (D) | K₁₃ | K₁₂ | K₂₃ | “K₁₃” w/Ring | (dB 20) |
| 1 | 15 μm | 0.0063 | 0.3200 | 0.0101 | 0.0032 | −5.88 |
| 2 | 22 μm | 0.00652 | 0.32824 | 0.01247 | 0.00255 | −8.15 |

The test results from Table 1 show that a 2-turn magnetic shield placed 22 μm away from the inner inductor may result in a 2.3 dB reduction in the coupling factor between the inductor 310 and the aggressor line 330 (e.g., as compared to a single-turn magnetic shield that is only 15 μm away from the inner inductor 320). Further, by placing the 2-turn magnetic shield 7 μm further away from the inner inductor 320 (e.g., compared to the single-turn magnetic shield), the reduction in magnetic coupling is achieved with negligible change to the inductance of the inductor 310 (e.g., K₁₂ is substantially the same for single- and 2-turn magnetic shields). For some embodiments, the number of turns (N) of the magnetic shield 320 and the separation distance (D) between the magnetic shield 320 and the inductor 310 are treated as variables which may be adjusted (e.g., depending on the degree of magnetic coupling between the inductor 310 and the aggressor line 330 and/or other inductive circuitry) to optimize the performance of the inductor 310 for a particular application.

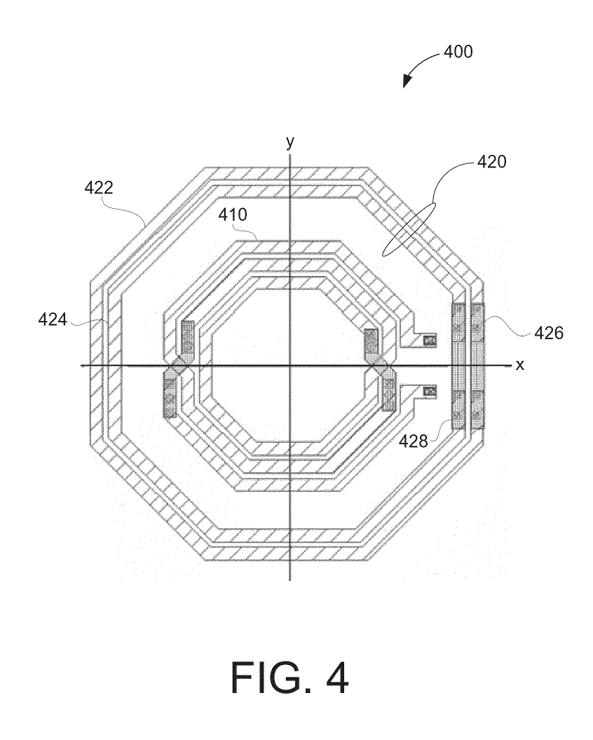

FIG. 4 depicts an inductive apparatus 400 with a magnetic shield comprising multiple inductive rings in accordance with some embodiments. The inductive apparatus 400 includes an inductor 410 and a magnetic shield 420. The inductor 410 and/or magnetic shield 420 may correspond to a number of conductive traces formed on a substrate (e.g., on an IC chip). The magnetic shield 420 surrounds the inductor 410 and shields it form unwanted magnetic coupling effects. For some embodiments, the magnetic shield includes multiple inductive rings 422 and 424. For example, each inductive ring 422 and 424 may be disposed on the same layer of an IC chip. Alternatively, each of the rings 422 and 424 may be disposed on a different layer of the IC chip.

The ends of the inductive rings 422 and 424 are shorted via connecting elements 426 and 428, respectively, thus forming two closed loops around the inductor 410. For some embodiments, the connecting elements 426 and/or 428 may be disposed on a different layer of the of the IC chip (e.g., separate from the rings 422 and 424), so as not to interfere with connections leading into and/or out from the inner inductor 410. Alternatively, one or more of the connecting elements 426 and/or 428 may be disposed on the same layer of the IC chip as the inductive rings 422 and 424, respectively. It should be noted that the magnetic shield 420 is shown to include two inductive rings 422 and 424 for simplicity only, and may include any number (N) of rings in other embodiments. Further, it should be noted that embodiments of the magnetic shield 420 are not limited to circular/octagonal shapes (e.g., the inductive rings 422 and 424 may be configured in any shape that forms a closed loop around the inductor 410).

When magnetic fields (e.g., from other on-chip circuitry) pass through the magnetic shield 420, a current is induced in each of the inductive rings 422 and 424 which creates multiple magnetic fields in the opposite direction. The opposing magnetic fields generated by the magnetic shield 420 (e.g., by each of the inductive rings 422 and 424) counters the effects of external magnetic fields passing through the inner inductor 410, thereby reducing a magnetic coupling between the inner inductor 410 and other nearby inductive circuitry (not shown for simplicity). As described above with reference to FIG. 3, the reduction in magnetic coupling is directly proportional to the number of turns of a multi-turn inductive ring (e.g., SR is inversely proportional to the number of turns). It will be appreciated to one of ordinary skill in the art that a similar principle applies to a magnetic shield comprised of multiple inductive rings (e.g., SR is inversely proportional to the number of rings). Thus, even greater reductions in magnetic coupling may be achieved by increasing the number of inductive rings used in the magnetic shield 420.

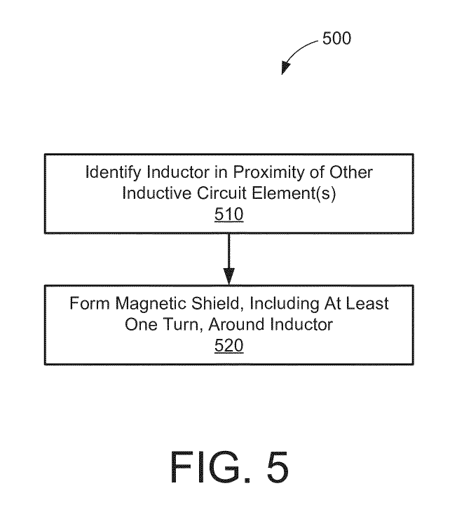

FIG. 5 is an illustrative flow chart depicting an exemplary operation 500 for constructing an inductive apparatus in accordance with some embodiments. It should be noted that the operation 500 may be applicable to a design stage (e.g., generating instructions to be executed by a processor in order to construct the inductive apparatus) and/or a manufacturing stage (e.g., physically printing the inductive apparatus onto an IC chip) of an IC construction process. Further, the operation 500 may be implemented as a set of instructions to be executed by one or more processors (not shown for simplicity).

The one or more processors first identify an inductor that is in the proximity of one or more other inductive circuit elements (510). The inductor may be within a threshold distance of the other inductive circuit elements, such that the inductances of the other inductive circuit elements may have an adverse effect on the inductance of the inductor (e.g., due to mutual inductance). For example, the other inductive circuit elements may be provided (or configured to be provided) on the same IC chip and/or substrate as the inductor. Further, at least some of the other inductive circuit elements may be provided on a separate chip and/or substrate.

Upon identifying such an inductor, the one or more processors may then form a magnetic shield around the inductor (520). For example, the magnetic shield may correspond to an inductive ring, including one or more turns, that surrounds the inductor. For some embodiments, the magnetic shield may correspond to an inductive ring with multiple turns. For example, the number of turns and/or placement of the magnetic shield (e.g., the distance of separation between the magnetic shield and the inductor) may be determined based on the magnetic coupling effects between the inductor and the one or more inductive circuit elements. More specifically, the magnetic shield may be configured to offset magnetic coupling effects of varying degree.

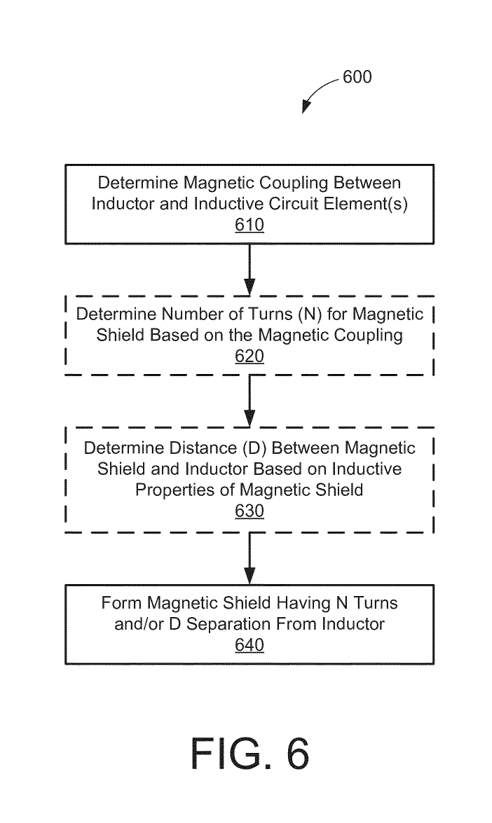

FIG. 6 is an illustrative flow chart depicting a more detailed operation 600 for constructing an inductive apparatus in accordance with some embodiments. It should be noted that the operation 600 may be applicable to a design stage (e.g., generating instructions to be executed by a processor in order to construct the inductive apparatus) and/or a manufacturing stage (e.g., physically printing the inductive apparatus onto an IC chip) of an IC construction process. Further, the operation 600 may be implemented as a set of instructions to be executed by one or more processors (not shown for simplicity). The operation 600 is described below with reference to FIG. 2, wherein the inductor 210 is formed on a substrate (e.g., silicon).

The one or more processors may determine a magnetic coupling between the inductor 210 and one or more other inductive circuit elements (610). As described above, the other inductive circuit elements may be provided (or configured to be provided) on the same IC chip and/or substrate as the inductor 210. Further, the other inductive circuitry may be on a separate chip and/or substrate close enough in proximity to exhibit mutual inductance with the inductor 210. For example, the other inductive circuit elements may include, but are not limited to: inductors, transformers, and/or conductive traces. With reference to FIG. 3, the magnetic coupling between the inductor (e.g., inductor 310) and each of the one or more other inductive circuit elements (e.g., aggressor line 330) may be represented by a coupling factor (K₁₃).

For some embodiments, the one or more processors may determine a number of turns (N) to be implemented for the magnetic shield 220 based on the magnetic coupling (620). As described above, the spur ratio (SR) is inversely proportional to the number of turns of the magnetic shield 220. Thus, a magnetic shield with a greater number of turns may provide greater shielding from magnetic coupling. For some embodiments, N may be chosen such that the magnetic coupling between the inductor 210 and the other inductive circuitry is reduced to a desired or tolerable (e.g., threshold) level. For other embodiments, N may be determined such that the induced magnetic field entirely offsets the unwanted magnetic field.

For some embodiments, the one or more processors may determine a distance of separation (D) by which to offset the magnetic shield 220 from the inductor 210 based, at least in part, on the inductive properties of the magnetic shield 220 (630). As described above with reference to FIG. 3, the presence of the magnetic shield 320 may reduce the inductance of the inductor 310 by a factor of (1−K₁₂²), which is proportional to N. Thus, D may be chosen to mitigate the coupling between the magnetic shield 220 and the inductor 210 (e.g., which allows for a significant reduction in magnetic coupling between the inductor 210 and an aggressor line (e.g., aggressor line 330 of FIG. 3), without substantially reducing with the inductance of the inductor 210). For example, increasing D (e.g., by increasing the circumference and/or diameter of the multi-turn inductive ring) may reduce the coupling effect of the magnetic shield 220 on the inductor 210. For some embodiments, D may be chosen such that the inductance of the inductor 210 is reduced by only a limited (e.g., threshold) amount.

For other embodiments, N and D may be chosen to balance the magnetic coupling between the inductor 210 and other inductive circuitry with the magnetic coupling between the inductor 210 and the magnetic shield 220 (620-630). For example, it is noted that increasing N has the effect of reducing the magnetic coupling between the inductor 210 and the other inductive circuitry while also reducing the effective inductance of the inductor 210 (e.g., by increasing the magnetic coupling between the inductor 210 and the magnetic shield 220). Increasing D, on the other hand, has the effect of increasing the effective inductance of the inductor 210 at the cost of potentially tempering (e.g., lessening) the effects of the magnetic shield 220 in reducing magnetic coupling between the inductor 210 and the other inductive circuitry. Thus, for some embodiments, a pair of values (N, D) may be chosen that is optimized for a particular application (e.g., circuit design and/or configuration).

After determining values for N and/or D, the one or more processors may form magnetic shield 220, around the inductor 210, having N number of turns and/or set a distance D from the inductor (640). For example, with reference to FIG. 2, the magnetic shield 220 may be formed as a conductive trace, on a substrate, surrounding the inductor 210. For some embodiments, each turn of the magnetic shield 220 may be disposed on the same device layer (e.g., as the inductor 210), while the turns themselves are connected to one another via a separate layer. For other embodiments, each of the turns may be disposed on a different layer of the device.

It should be noted that steps 620 and 630 correspond to optional embodiments which may be included and/or omitted in any combination. For example, in some embodiments, the one or more processors may determine only the N turns of the magnetic shield 220 (e.g., thereby omitting step 630). In other embodiments, the one or more processors may determine only the separation distance D between the magnetic shield 220 and the inductor 210 (e.g., thereby omitting step 620). Still further, in some embodiments, the one or more processors may determine both N and D of the magnetic shield 220 (e.g., as described above).

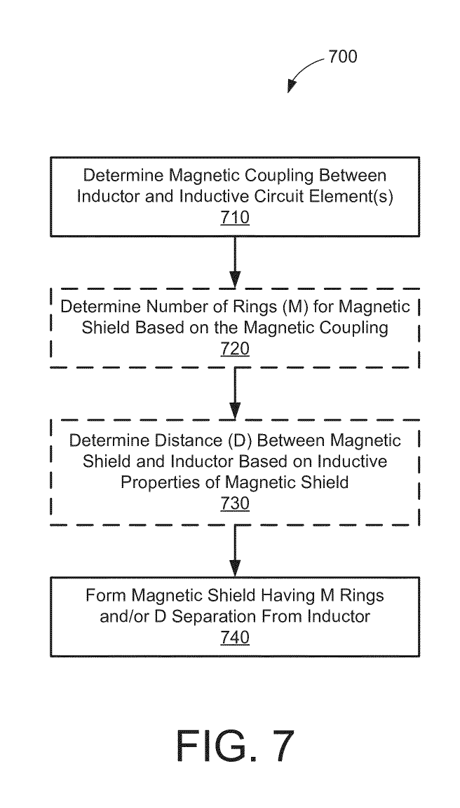

FIG. 7 is an illustrative flow chart depicting a more detailed operation 700 for constructing an inductive apparatus in accordance with other embodiments. It should be noted that the operation 700 may be applicable to the design stage and/or the manufacturing stage of an IC construction process. Further, the operation 700 may be implemented as a set of instructions to be executed by one or more processors (not shown for simplicity). The operation 700 is described below with reference to FIG. 4, wherein the inductor 410 is formed on a substrate (e.g., silicon).

The one or more processors may determine a magnetic coupling between the inductor 410 and one or more other inductive circuit elements (710). As described above, the other inductive circuit elements may be provided (or configured to be provided) on the same IC chip and/or substrate as the inductor 410. Further, the other inductive circuitry may be on a separate chip and/or substrate close enough in proximity to exhibit mutual inductance with the inductor 410. For example, the other inductive circuit elements may include, but are not limited to: inductors, transformers, and/or conductive traces. With reference to FIG. 3, the magnetic coupling between the inductor (e.g., inductor 310) and each of the one or more other inductive circuit elements (e.g., aggressor line 330) may be represented by a coupling factor (K₁₃).

For some embodiments, the one or more processors may determine a number of rings (M) for the magnetic shield 420 based on the magnetic coupling (720). As described above, a magnetic shield with a greater number of rings may provide greater shielding from magnetic coupling. For some embodiments, M may be chosen such that the magnetic coupling between the inductor 410 and the other inductive circuitry is reduced to a desired or tolerable (e.g., threshold) level. For other embodiments, M may be determined such that the induced magnetic field entirely offsets the unwanted magnetic field.

For some embodiments, the one or more processors may determine a distance of separation D by which to offset the magnetic shield 420 from the inductor 410 based, at least in part, on the inductive properties of the magnetic shield (730). For example, the presence of the magnetic shield 420 may reduce the inductance of the inductor 410 by a factor proportional to M. Thus, D may be chosen to mitigate the coupling between the magnetic shield 420 and the inductor 410. For example, increasing D (e.g., by increasing the average circumference and/or diameter of the inductive rings) may reduce the coupling effect of the magnetic shield 420 on the inductor 410. For some embodiments, D may be chosen such than the inductance of the inductor 410 is reduced by only a limited (e.g., threshold) amount.

For other embodiments, M and D may be chosen to balance the magnetic coupling between the inductor 410 and other inductive circuitry with the magnetic coupling between the inductor 410 and the magnetic shield 420 (720-730). For example, it is noted that increasing M has the effect of reducing the magnetic coupling between the inductor 410 and the other inductive circuitry while also reducing the effective inductance of the inductor 410 (e.g., by increasing the magnetic coupling between the inductor 410 and the magnetic shield 420). Increasing D, on the other hand, has the effect of increasing the effecting inductance of the inductor 410 at the cost of potentially tempering the effects of the magnetic shield 420 in reducing magnetic coupling between the inductor 410 and the other inductive circuitry. Thus, for some embodiments, a pair of values (M, D) may be chosen that is optimized for a particular application (e.g., circuit design and/or configuration).

After determining values for M and/or D, the one or more processors may form magnetic shield 420, around the inductor 410, having M number of inductive rings and/or set a distance D from the inductor 410 (740). For example, with reference to FIG. 4, the magnetic shield 420 may be formed as a number of conductive traces, on a substrate, surrounding the inductor 410. For some embodiments, each of the inductive rings may be disposed on the same device layer (e.g., as the inductor). For other embodiments, each of the inductive rings may be disposed on a different device layer.

It should be noted that steps 720 and 730 correspond to optional embodiments which may be included and/or omitted in any combination. For example, in some embodiments, the one or more processors may determine only the M rings of the magnetic shield 420 (e.g., thereby omitting step 730). In other embodiments, the one or more processors may determine only the separation distance D between the magnetic shield 420 and the inductor 410 (e.g., thereby omitting step 720). Still further, in some embodiments, the one or more processors may determine both M and D of the magnetic shield 220 (e.g., as described above).

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense. For example, the method steps depicted in the flow charts of FIGS. 5-7 may be performed in other suitable orders, multiple steps may be combined into a single step, and/or some steps may be omitted.

What is claimed is:

1. An inductive apparatus comprising:
an inductor; and
a magnetic shield surrounding the inductor, wherein the magnetic shield comprises an inductive ring including at least two turns to shield the inductor from magnetic coupling effects.

2. The apparatus of claim 1, wherein the magnetic shield is to reduce a magnetic coupling between the inductor and an inductive circuit element external to the apparatus.

3. The apparatus of claim 2, wherein a number of turns of the inductive ring is based on the magnetic coupling between the inductor and the inductive circuit element.

4. The apparatus of claim 3, wherein a distance between the magnetic shield and the inductor is based on the number of turns of the inductive ring.

5. The apparatus of claim 4, wherein a greater number of turns of the inductive ring correlates with a greater distance between the magnetic shield and the inductor.

6. The apparatus of claim 4, wherein the distance between the magnetic shield and the inductor is to offset a magnetic coupling between the inductor and the magnetic shield.

7. The apparatus of claim 4, wherein the distance between the magnetic shield and the inductor corresponds with a circumference of the inductive ring.

8. An inductive apparatus comprising:
an inductor; and
a magnetic shield surrounding the inductor, wherein the magnetic shield comprises at least two inductive rings to shield the inductor from magnetic coupling effects.

9. The apparatus of claim 8, wherein the magnetic shield is to reduce a magnetic coupling between the inductor and an inductive circuit element external to the apparatus.

10. The apparatus of claim 9, wherein a number of inductive rings of the magnetic shield is based on the magnetic coupling between the inductor and the inductive circuit element.

11. The apparatus of claim 10, wherein a distance between the magnetic shield and the inductor is based on the number of inductive rings.

12. The apparatus of claim 11, wherein a greater number of inductive rings correlates with a greater distance between the magnetic shield and the inductor.

13. The apparatus of claim 11, wherein the distance between the magnetic shield and the inductor is to offset a magnetic coupling between the inductor and the magnetic shield.

14. The apparatus of claim 11, wherein the distance between the magnetic shield and the inductor corresponds with an average circumference of the inductive rings.

15. A system comprising:
a first inductor;
a second inductor; and
a first magnetic shield to reduce a magnetic coupling between the first inductor and the second inductor, wherein the first magnetic shield comprises a first inductive ring surrounding one of the first inductor or the second inductor, and wherein the first inductive ring includes at least two turns.

16. The system of claim 15, further comprising:
a second magnetic shield, wherein the second magnetic shield comprises a second inductive ring surrounding the other inductor.

17. The system of claim 15, wherein the first magnetic shield surrounds the first inductor, and wherein the second inductor is an aggressor line external to the first magnetic shield.

18. The system of claim 15, wherein a number of turns of the first inductive ring is based on the magnetic coupling between the first inductor and the second inductor.

19. The system of claim 18, wherein a distance between the first magnetic shield and the first inductor is based on the number of turns of the first inductive ring.

20. The system of claim 18, wherein a greater number of turns of the first inductive ring correlates with a greater distance between the first magnetic shield and the first inductor.

21. The system of claim 18, wherein the distance between the first magnetic shield and the first inductor is to offset a magnetic coupling between the first inductor and the first magnetic shield.

22. The system of claim 18, wherein the distance between the first magnetic shield and the first inductor corresponds with a circumference of the first inductive ring.

23. A method of constructing an inductive apparatus, the method comprising:
forming an inductor on a substrate; and
forming a magnetic shield on the substrate, wherein the magnetic shield surrounds the inductor and comprises an inductive ring including at least two turns to shield the inductor from magnetic coupling effects.

24. The method of claim 23, wherein the magnetic shield is to reduce a magnetic coupling between the inductor and an external inductive circuit element.

25. The method of claim 24, wherein forming the magnetic shield comprises:
determining a number of turns for the inductive ring based, at least in part, on the magnetic coupling between the inductor and the inductive circuit element.

26. The method of claim 25, wherein the reduction in the magnetic coupling is proportional to the number of turns of the inductive ring.

27. The method of claim 25, wherein forming the magnetic shield comprises:
determining a distance between the magnetic shield and the inductor based, at least in part, on the number of turns of the inductive ring.

28. The method of claim 27, wherein a greater number of turns of the inductive ring correlates with a greater distance between the magnetic shield and the inductor.

29. The method of claim 27, wherein determining the distance between the magnetic shield and the inductor comprises:
determining the distance to offset a magnetic coupling between the inductor and the magnetic shield.

30. The method of claim 27, wherein the distance between the magnetic shield and the inductor corresponds with a circumference of the inductive ring.
